(19) United States
(12) Patent Application Publication
(10) Pub. No.: US 2004/0146089 A1
(43) Pub. Date: Jul. 29, 2004

(54) Radio communication device and radio communication method

(76) Inventor: Katsuhiko Hiramatsu, Yokosuka-shi (JP)

Correspondence Address: STEVENS DAVIS MILLER & MOSHER, LLP, 1615 L STREET, NW, SUITE 850, WASHINGTON, DC, 20036, US

(21) Appl. No.: 10/477,554

(22) PCT Filed: Dec. 27, 2002
(86) PCT No.: PCT/JP02/13770

(30) Foreign Application Priority Data
Jan. 7, 2002 (JP) 2002-616

(51) Int. Cl. H04B 1/707

(52) U.S. Cl. 375/144

(57) ABSTRACT

A transmitting side separates a transmission signal into a first information signal by a combination of spread codes and a second information signal except the first information signal, selects a combination of the spread codes corresponding to the first information signal, and performs spread modulation processing to the second information signal using the spread codes of the selected combination, and a receiving side performs despread processing to a received signal by the spread codes used on the transmitting side, selects a combination of the spread codes used on the transmitting side by use of a despread signal, and obtains the first information signal by the combination of the spread codes from the combination of the spread codes.

### TECHNICAL FIELD

The present invention relates to a digital radio communication system, and particularly to a radio communication apparatus and radio communication method used in CDMA (Code Division Multiple Access).

### BACKGROUND ART

With the recent development of the digital radio communication system, service for distributing data such as a moving image and the like, has been put to practical use in a digital radio communication system. For this reason, it is desired that more numerous information can be transmitted in the digital radio communication system.

In order to transmit more numerous information, an M-ary modulation system such as 8PSK (8 Phase Shift Keying), 16QAM (16 Quadrature Amplitude Modulation), 64QAM (64 Quadrature Amplitude Modulation) has been used. This increases the number of information bits to be transmitted per one symbol to make it possible to improve transmission efficiency.

However, for providing the service for distributing data such as a moving image and the like, higher transmission efficiency has been desired in addition to the use of the aforementioned M-ary modulation system.

### DISCLOSURE OF INVENTION

An object of the present invention is to provide a radio communication apparatus and radio communication method capable of more increasing an amount of information to be transmitted in addition to the use of an M-ary modulation system.

The above object can be attained in such a manner that a transmitting side separates a transmission signal into a first information signal by a combination of spread codes and a second information signal except the first information signal, selects a combination of the spread codes corresponding to the first information signal, and performs spread modulation processing to the second information signal using the spread codes of the selected combination, and a receiving side performs despread processing to a received signal by the spread codes used on the transmitting side, selects a combination of the spread codes used on the transmitting side by use of, a despread signal, and obtains the first information signal by the combination of the spread codes from the combination of the spread codes, and thereby making it possible to place information on the combination of the spread codes to perform data transmission, and to improve transmission efficiency in the data transmission.

### BRIEF DESCRIPTION OF DRAWINGS

FIG. 1 is a block diagram illustrating a configuration of a transmitting side apparatus, which is a radio communication apparatus according to Embodiment 1 of the present invention;

FIG. 2 is a block diagram illustrating a configuration of a receiving side apparatus, which is a radio communication apparatus according to Embodiment 1 of the present invention;

FIG. 3 is a view illustrating a data sequence;

FIG. 4 is a view illustrating a corresponding table used in a radio communication method of the present invention;

FIG. 5 is a view illustrating the relationship between the number of spread codes and the number of transmission bit per symbol;

FIG. 6 is a view illustrating the relationship between the number of spread codes and the number of transmission bit per symbol;

FIG. 7 is a view illustrating the relationship between the number of spread codes and the number of transmission bit per symbol;

FIG. 8 is a view illustrating the relationship between the number of spread codes and the number of transmission bit per symbol;

FIG. 9 is a block diagram illustrating a configuration of a transmitting side apparatus, which is a radio communication apparatus according to Embodiment 2 of the present invention; and

FIG. 10 is a block diagram illustrating a configuration of a receiving side apparatus, which is a radio communication apparatus according to Embodiment 2 of the present invention.

### BEST MODE FOR CARRYING OUT THE INVENTION

As a result of paying attention to the point that the predetermined number of spread codes was selected from among spread codes to be used in the CDMA multicode transmission, the present inventor came to achieve this invention by discovering that provision of information to the combination of spread codes could be made possible at the time of selecting the spread code.

In other words, the outline of the present invention is that a transmitting side separates a transmission signal into a first information signal by a combination of spread codes and a second information signal except the first information signal, selects a combination of the spread codes corresponding to the first information signal, and performs spread modulation processing to the second information signal using the spread codes of the selected combination, and a receiving side performs despread processing to a received signal by the spread codes used on the transmitting side, selects the combination of the spread codes used on the transmitting side by use of a despread signal, and obtains the first information signal by the combination of the spread codes from the combination of the spread codes, and thereby placing information on the combination of the spread codes to perform data transmission to improve transmission efficiency in the data transmission.

Embodiments of the present invention will be specifically explained with reference attached drawings.

(Embodiment 1)

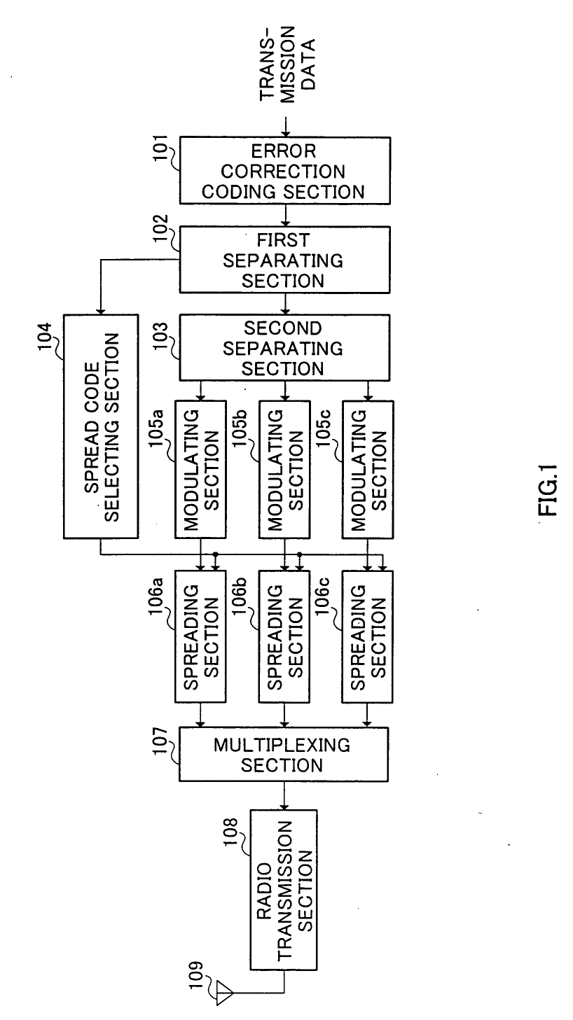

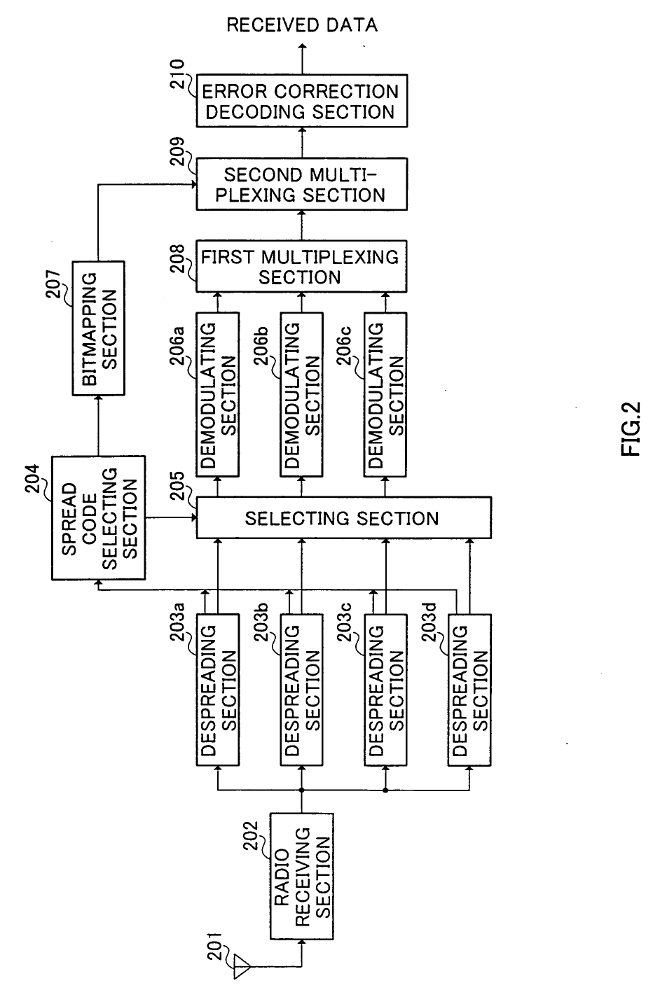

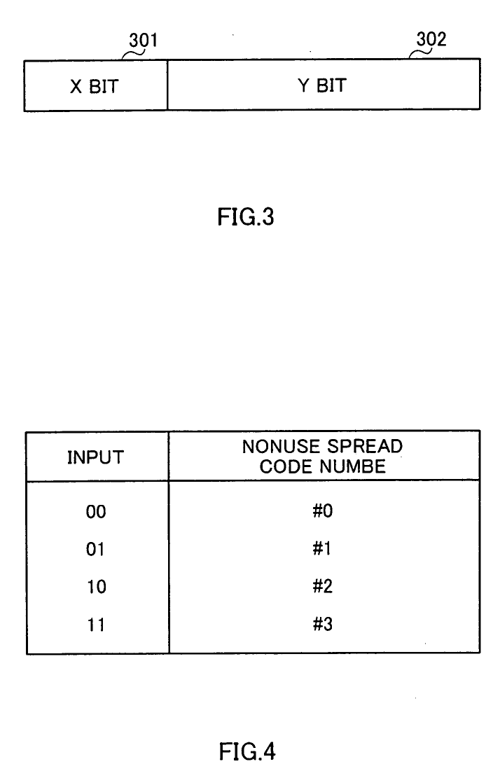

FIG. 1 is a block diagram illustrating a configuration of a transmitting side apparatus, which is a radio communication apparatus according to Embodiment 1 of the present invention. Moreover, FIG. 2 is a block diagram illustrating a configuration of a receiving side apparatus, which is a radio communication apparatus according to Embodiment 1 of the present invention. In this embodiment, a signal to be transmitted has a configuration as illustrated in FIG. 3, and an information bit (X bit) 301 of spread codes and a normal information bit (Y bit) 302 are provided therein.

In the transmitting side apparatus illustrated in FIG. 1, transmission data is subjected to error correction coding by an error correction coding section 101, and a signal subjected to error correction coding is output to a first separating section 102. The first separating section 102 separates the signal shown in FIG. 3, and outputs the information bit (X bit) 301 of spread codes to a spread code selecting section 104, and outputs the normal information bit (Y bit) 302 to a second separating section 103.

The second separating section 103 separates the normal information bit into a predetermined number (the number of using codes at a multicode transmitting time, three in this case), and outputs separated signals to modulating sections 105a to 105c, respectively. The modulating section 105a to 105c provide modulation processing to the separated signals, and output modulated signals to spreading sections 106a to 106c, respectively.

The spread code selecting section 104 selects a spread code to be used in the multicode transmission by use of the information bit 301 of spread codes. Information (using spread code number) of the selected spread code is output to the spreading sections 106a to 106c, respectively.

The spreading sections 106a to 106c provide spread modulation processing to the information bit 302 subjected to separation and modulation using the spread code selected by the spread code selecting section 104. The signals subjected to spread modulation processing are output to a multiplexing section 107.

The multiplexing section 107 multiplexes the spread signals subjected to spread modulation by the respective spreading sections 106a to 106c and outputs the multiplexed signal to a radio transmission section 108. The radio transmission section 108 provides predetermined radio transmission processing (for example, D/A conversion, upconvert, and the like) to the multiplexed signal, and transmits the signal subjected to the radio transmission processing through an antenna 109.

The signal transmitted from the transmitting side apparatus is received by a radio receiving section 202 through an antenna 201 of a receiving side apparatus shown in FIG. 2. The radio receiving section 202 provides predetermined radio reception processing (for example, down convert, A/D conversion, and the like) to the received signal, and outputs the signal subjected to the radio reception processing to despreading sections 203a to 203d, respectively.

The despreading sections 203a to 203d provide despreading processing to the signals subjected to the radio reception processing by use of the respective spread codes used by the transmitting side apparatus, and outputs the signals (despread signals) subjected to the despreading processing to a spread code selecting section 204 and a selecting section 205.

The spread code selecting section 204 selects a spread code used by the transmitting side apparatus by the despread processing, and outputs information (for example, spread code number) of the selected spread code to the selecting section 205 and a bitmapping section 207. The selecting section 205 selects outputs from the despreading sections 203a to 203d based on information of the spread codes from the spread code selecting section 204. The selected despread signals are output to demodulating sections 206a to 206c, respectively.

The demodulating sections 206a to 206c perform demodulation processing to the selected despread signals, and output the demodulated signal (demodulation signals) to a first multiplexing section 208. The first multiplexing section 208 multiplexes the respective demodulation signals and outputs an obtained multiplexed signal to a second multiplexing section 209 as the information bit. The bit mapping section 207 performs bitmapping to the information bit corresponding to information of spread codes, and outputs it to the second multiplexing section 209 as the information bit of spread codes.

The second multiplexing section 209 multiplexes the information bit of the spread codes output from the bit mapping 207 and the information bit output from the first multiplexing section 208, and outputs a signal shown in FIG. 3 to an error correction decoding section 210. The error correction decoding section 210 performs error correction decoding to the signal shown in FIG. 3 and outputs reception data.

An explanation will be next given of a case that the radio communication method of the present invention is performed using the radio communication apparatus having the aforementioned configuration.

First, an explanation will be herein given of the principle in which an amount of transmission is increased by information of spread codes.

In the CDMA transmission, if modulation multi-value number is M, M bits can be transmitted per one symbol time. Moreover, if a spreading ratio is S, the number of transmission bits per S chips can be expressed by the following equation (1) when all spread codes are multiplexed to transmit.

Bₛ=M×S (1)

Moreover, when only N spread codes are multiplexed to transmit, this can be expressed by the following equation (2):

B_{N}=M×S (2)

Thus, in the case of transmitting N spread codes, the transmission rate reduces in the case of N<S.

Generally, in the case of designing a system of reuse 1, which uses the same frequency as that of the adjacent cell under multicell environments, spread is introduced and the number of spread codes N per one cell is used to be N<S, and the spread codes of (S-N) are allocated in order to suppress interference from the other cell.

This makes it possible to provide information to the combination of spread codes and to increase the transmission rate. Particularly, in the case of allocating a certain transmission time to one user, since a degree of freedom increases in selecting the spread code, the transmission rate can be more improved.

Here, if the spread ratio is S and the number of spread codes is N, combinations of ₛC_{N} can be obtained. At this time, the following equation (3) can express how many bits can be expressed:

B_{C}=└log₂(ₛC_{N}) (3)

Additionally, in the above equation,

└x┘ (4)

is a calculation for obtaining integers less than x.

Accordingly, when information is provided to the combination of spread codes, information that can be transmitted per S chip time can be expressed by the following equation (5):

B_{C}=B_{N}+B_{C}=M×N└log₂(_{S}C_{N}) (5)

In this way, when such variables M, S, N by which the above equation (5) is increased to the above equation (1) are selected, the transmission rate can be increased by use of a parallel combination of spread codes.

FIG. 5 is a view illustrating the relationship between the number of spread codes and the number of transmission bits per symbol, and more specifically a view illustrating a percentage increase of a transmission rate when all spread codes are multiplexed where a spread ratio S and the number of spread codes N to be subjected to code multiplex are used as parameters in the case of QPSK (corresponding to M=2). In other words, the following equation (6), which is a value obtained by dividing the above equation (5) by the above equation (1), is plotted.

$$\begin{matrix}η = \frac{B}{{B}_{S}} \\ = \frac{1}{S} ( N + \frac{1}{M} ⌊ {log}_{2} ( {}_{S}^{}{C}{}_{N}^{} ) ⌋ )\end{matrix} \qquad ( 6 )$$

In FIG. 5, a horizontal axis indicates the number of multiplexed spread codes and a vertical axis indicates the number of transmission bits per one symbol. When the spread ratio (S) is 4, multiplexing can be performed up to 4 spread codes where the number of transmission bits per one symbol is one, and when the spread ratio (S) is 32, multiplexing can be performed up to 32 spread codes where the number of transmission bits per one symbol is one. In addition, 1 of the vertical axis indicates that the transmission rate is equal in the case where no spread is used or all spread codes are multiplexed by spreading. Accordingly, the transmission rate is improved when a value of the vertical axis which is higher than 1 is indicated.

Two examples are herein shown. First, a first example shows a case in which the amount of transmission is increased as compared with a case in which no spreading is performed by a combination of the spread codes or a case in which all spread codes are multiplexed by spreading to perform transmission.

In the case of the spread ratio (S) of 32, when information is provided to the combination of spread codes without performing code multiplex, 71 bits, which is 1.109 times as many as the general case in which 64 bits can be generally transmitted per 32 chip time, can be transmitted. For example, when N=24, 48=24×2 by 24 code multiplex is established and the combinations of 24 codes become ₃₂C₂₄=10, 518, 300. This results in 23 bits in bit conversion. Accordingly, 71=48+23 bits can be obtained, and the amount of transmission is increased by 7 bits.

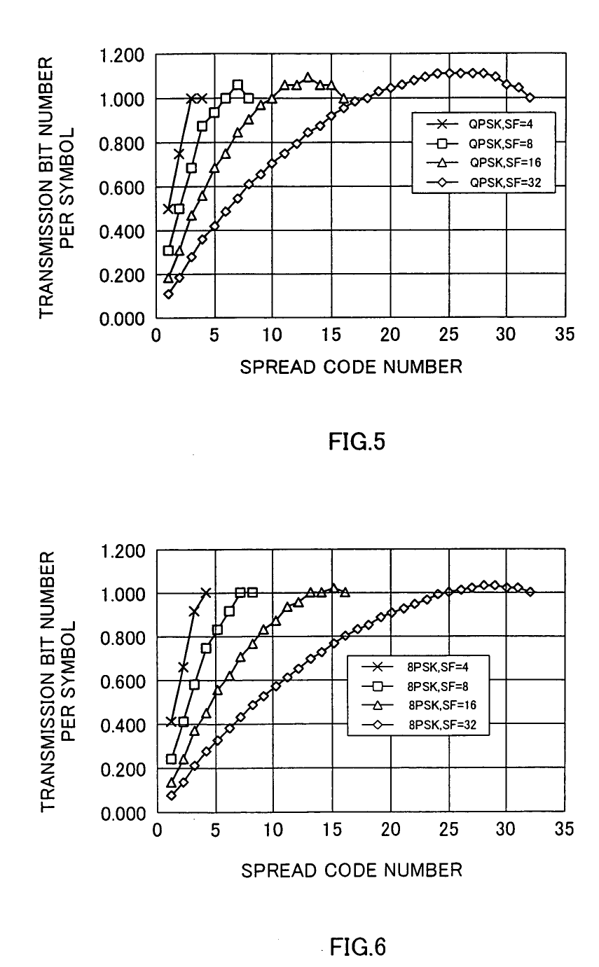

In such the system that provides information to the parallel combinations of spread codes, the amount of transmission is increased up to 8PSK of modulation multi-value number M=3 as shown in FIG. 6. However, when the modulation multi-value number M is greater than 16PSK of modulation multi-value number M=4, the amount of transmission becomes 1% or less even if it is increased.

Next, a second example shows a case (improvement) in which information is provided to the combinations of the spread codes to increase the amount of transmission in a case where the amount of transmission is decreased by allocating the part of spread codes to other cell interference after spreading.

In the case of the spread ratio S and the number of code multiplex numbers N, the amount of transmission bits becomes as in the above equation (2). In contrast to this, when the information is provided to the selected code, the result can be shown as in the above equation (5). Then, the improvement ratio of the above equation (5) to the above equation (2) can be expressed by the following equation (7).

$$\begin{matrix}μ = \frac{B}{{B}_{N}} \\ = ( 1 + \frac{1}{M \times N} ⌊ {log}_{2} ( {}_{S}^{}{C}{}_{N}^{} ) ⌋ )\end{matrix} \qquad ( 7 )$$

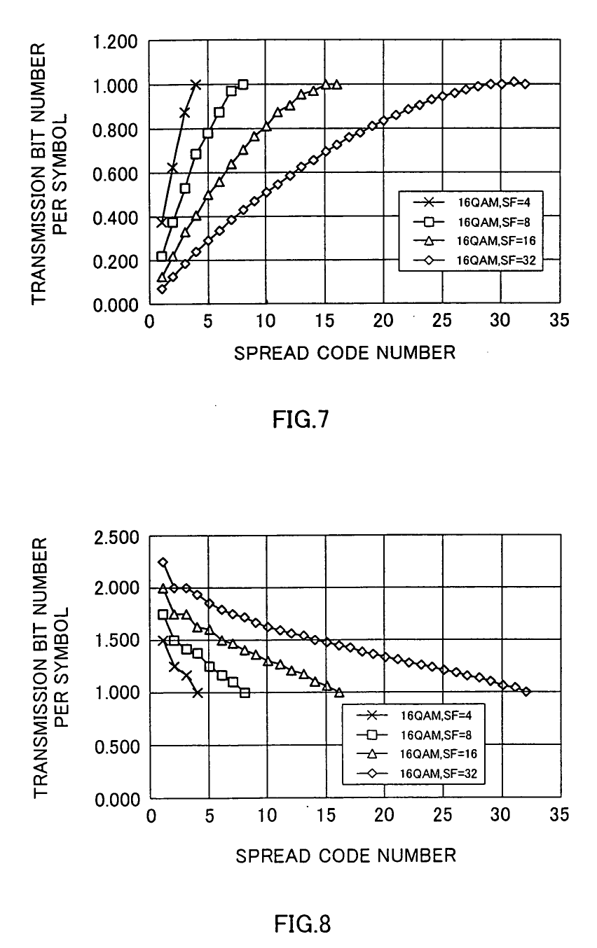

FIGS. 7 and 8 are views each illustrating the relationship between the number of spread codes and the number of transmission bit per symbol, and more specifically FIG. 7 is a view illustrating a percentage increase (corresponding to the above equation (6)) of the transmission rate in a case where all spread codes are multiplexed at the time of modulation multi-value number M=4 (16QAM) and FIG. 8 is a view illustrating a percentage increase (corresponding to the above equation (7)) of the transmission rate to in a case where N codes are multiplexed.

As is obvious from FIG. 7, when the modulation multi-value number is 4, 4-bit information cannot be transmitted if one code of spread cods is not used. Accordingly, the number of bits cannot be easily increased even if the parallel combination of the spread codes is used. In FIG. 7, at only the time of S=32 and N=31, the number of transmittable bits is increased by one, resulting in 129 bits.

Moreover, as is obvious from FIG. 8, when the number of spread codes N is small, the number of information bits by the parallel combination is increased. This is because a reduction in the number of transmission bits can be restrained even when the number of multiplexed spread codes is allocated to the other cell interference. For example, at the time of S=32 and N=20, a reduction from 128 bits to 80 bits is caused when all codes are multiplexed, but the use of the parallel combination increases the number of bits by 27 bits, resulting in 107 bits. In other words, the use of the parallel combination makes it possible to keep the transmission rate, which was reduced to 62.5% at the time of N=20, to 89.2%.

As mentioned above, information is placed on the spread code by the radio communication method of the present invention, thereby making it possible to improve the transmission efficiency.

An explanation will be next given of a case in which transmission is actually carried out using spread code information and general information.

In the transmitting side apparatus shown in FIG. 1, transmission data subjected to error correction coding by the first separating section 102 is separated into the information bit 301 to be transmitted by information of spread codes (combination of spread codes) and the information bit 302 to be transmitted by modulation. For example, when the modulation multi-value number is M, the spread ratio is S and the number of multiplexed spread codes is N, the number of transmission bits becomes as shown in the above equation (2), and the number of bits for which information bit 302 is transmitted by modulation becomes as shown in the above equation (3).

Information bit B_{c} to be transmitted by the combination of spread codes is output to the spread code selecting section 104. The spread code selecting section 104 selects a spread code to be used to correspond to information bit B_{c}. For example, a spread code with a number corresponding to information bit B_{c} is regarded as nonuse, and spread codes except such the spread code is used. More specifically, the spread code selecting section 104 holds a corresponding table as shown in FIG. 4, and specifies a spread code number as nonuse according to information bit B_{c} (input), and outputs information of spread codes except such the spread code to the spreading sections 106a to 106c.

The corresponding table illustrated in FIG. 4 shows a case in which the number of using spread codes is 4. This is to simplify the explanation, and the number of using spread codes can be similarly applied the other numbers except 4. In FIG. 4, when the information bits are “00”, spread code number #0 is not used, when the information bits are “01”, spread code number #1 is not used, when the information bits are “10”, spread code number #2 is not used, and when the information bits are “11”, spread code number #3 is not used.

Accordingly, when the information bits are “00”, spread code numbers #1 to #3 are used, when the information bits are “01”, spread code numbers #0, #2, #3 are used, when the information bits are “10”, spread code numbers #0, #1, #3 are used, and when the information bits are “11”, spread code numbers #0 to #2 are used. Information of the spread codes selected in this way is output to the spreading sections 106a to 106c, respectively.

The above has explained the case in which the spread code selecting section 104 puts the information bit into correspondence with nonuse spread code number and selects a spread code except nonuse spread code, however, in the present invention, after the information bit and the using spread code number are made to correspond to each other, the spread code to be used may be selected directly from the information bit. For example, the spread code selecting section prepares combinations in advance in a case where the number of spread codes N is selected to the spread ratio S, and selects a combination of the spread codes to be used to correspond to information bit B_{C}. In other words, 2^{Bc} possible combinations are selected in advance from among ₛC_{N} combinations in ascending order of the spread code numbers, and a combination of the spread codes is selected from among the combinations.

The spreading sections 106a to 106c use the spread code selected by the spread code selecting section 104 respectively, and perform spread modulation processing to the information bits subjected to modulation by the multi-value number M. For example, when the information bits of the spread codes are “00”, the spread codes to be used are #1 to #3, so that the spreading section 106a uses spread code #1, the spreading section 106b uses spread code #2, and the spreading section 106c uses spread code #2.

After being multiplexed, the spread-modulated signal is subjected to a predetermined radio transmission processing, and thereafter being transmitted.

In the receiving side apparatus illustrated in FIG. 2, the despreading sections 203a to 203d perform despread processing after the received signal is subjected to a predetermined radio reception processing. At this time, the despreading section 203a performs despreading using despread code #0, the despreading section 203b performs despreading using despread code #1, the despreading section 203c performs despreading using despread code #2, and the despreading section 203d performs despreading using despread code #3.

Despread signals of the respective despreading sections 203a to 203d are output to the spread code selecting section 204. The spread code selecting section 204 measures power of the despread signals and determines upper predetermined numbers as the used spread codes. Here, since the transmitting side apparatus uses three spread codes, the spread code selecting section 204 measures power of the despread signals and determines that upper three codes are used. For example, when the information bits of the spread codes are “00”, it is determined that spread code numbers #1 to #3 are used.

Information of spread codes (spread code number) is output to the bit mapping section 207. The bit mapping section 207 converts the spread code number to a bit sequence using the corresponding table shown in FIG. 4 that is held by the spread code selecting section 104 of the transmission side apparatus. For example, since the spread code numbers #1 to #3 are used, conversion to information bits “00” is performed.

While, the despread signal is multiplexed after being demodulated, and multiplexed with the information bit of the spread signal converted to the bit sequence by the second multiplexing section 209. The multiplexed signal is subjected to error correction decode processing and output as receiving data.

In this way, according to the present invention, the transmitting side separates the transmission signal into the first information signal by a combination of spread codes and the second information signal except the first information signal, selects a combination of the spread codes corresponding to the first information signal, and performs spread modulation processing to the second information signal using the spread codes of the selected combination, and the receiving side performs despread processing to a received signal by the spread codes used on the transmitting side, selects the combination of the spread codes used on the transmitting side by use of a despread signal, and obtains the first information signal by the combination of the spread codes from the combination of the spread codes, and thereby placing information on the combination of the spread codes to perform data transmission to make it possible to improve transmission efficiency in the data transmission.

(Embodiment 2)

This embodiment will explain a case in which error correction coding is performed to the information bit 301 of spread codes and the information bit 302 individually in connection with the signal shown in FIG. 3.

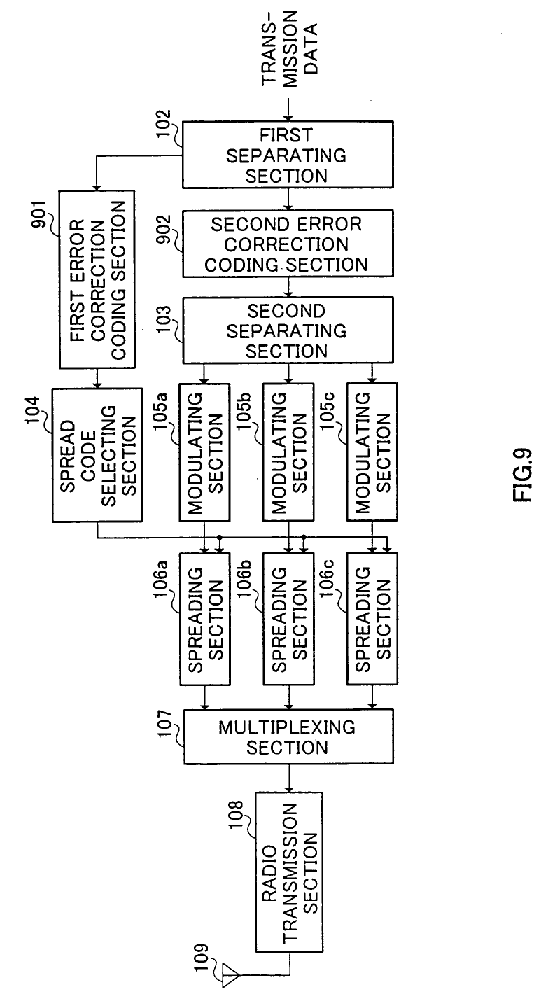

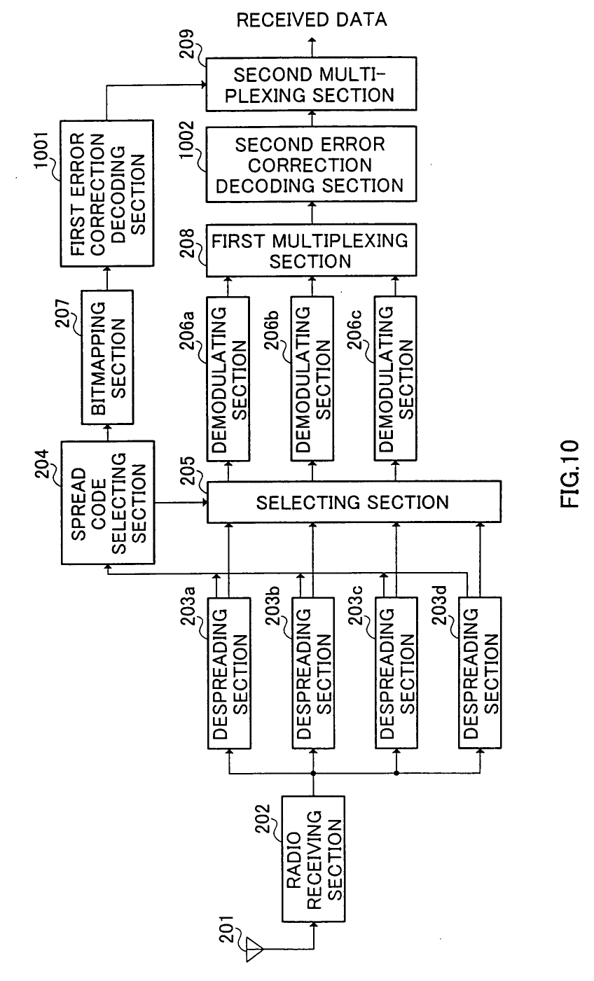

FIG. 9 is a block diagram illustrating a configuration of a transmitting side apparatus, which is a radio communication apparatus according to Embodiment 2 of the present invention. Additionally, in FIG. 9, the same reference numerals as those of FIG. 1 are added to the same components as those of FIG. 1, and the specific explanation will be omitted. FIG. 10 is a block diagram illustrating a configuration of a receiving side apparatus, which is a radio communication apparatus according to Embodiment 2 of the present invention. Additionally, in FIG. 10, the same reference numerals as those of FIG. 2 are added to the same components as those of FIG. 2, and the specific explanation will be omitted.

The transmitting side apparatus shown in FIG. 9 includes a first error correction coding section 901, which performs error correction coding on the information bit 301 of spread codes in FIG. 3, in place of the error correction coding section 101, and a second error correction coding section 902, which performs error correction coding on the normal information bit 302.

The receiving side apparatus shown in FIG. 10 includes a first error correction decoding section 1001, which performs error correction decoding on the information bit 301 of spread codes in FIG. 3, in place of the error correction decoding section 210, and a second error correction decoding section 1002, which performs error correction decoding on the normal information bit 302.

In the transmitting side apparatus having the aforementioned configuration, the first separating section 102 separates transmission data into information bit 301 of spread codes and the information bit 302, outputs the information bit 301 of spread codes to the first error coding section 901, and outputs the information bit 302 to the second error correction coding section 902.

The first error coding section 901 performs error correction coding to the information bit 301 of spread codes and outputs the information bit 301 of spread codes subjected to error correction coding to the spread code selecting section 104. The second error coding section 902 performs error correction coding to the information bit 302 and outputs the information bit 302 subjected to error correction coding to the second separating section 103.

Processing of the subsequent stage from the spread code selecting section 104 and the second separating section 103 is the same as that of Embodiment 1.

In the receiving side apparatus having the aforementioned configuration, processing up to the bit mapping section 207 and the first multiplexing section 208 is the same as that of Embodiment 1.

In the first error correction decoding section 1001, the information bit 301 of the bitmapped spread codes is subjected to error correction decoding corresponding to the error correction coding provided on the transmitting side and the signal subjected to error correction decoding is output to the second multiplexing section 209.

In the second error correction decoding section 1002, the signal (information bit 302) multiplexed by the first multiplexing section 208 is subjected to error correction decoding corresponding to the error correction coding provided on the transmitting side and the signal subjected to error correction decoding is output to the second multiplexing section 209.

In this way, the information bit 301 of spread codes and the information bit 302 are individually subjected to error correction coding, thereby making it possible to perform appropriate error correction coding/decoding to the information bit 301 of spread codes and the information bit 302, respectively, and to carry out high accurate error correction, and to improve reception performance.

Additionally, the system of error correction coding provided to the information bit 301 of spread codes and the system of error correction coding provided to the information bit 302 may be the same as each other or different from each other.

The present invention is not limited to the aforementioned Embodiments 1 and 2 and various changes can be possible. For example, in the present invention, the modulation multi-value number is not limited to the aforementioned Embodiments 1 and 2 and changes can be possible.

The radio communication apparatus and radio communication method of the present invention can be applied to a digital radio communication system, particularly a CDMA radio base station apparatus and communication terminal apparatus. This makes it possible to improve transmission efficiency in data transmission.

As is obvious from the above explanation, according to the radio communication apparatus and radio communication method of the present invention, the transmitting side separates the transmission signal into the first information signal by a combination of spread codes and the second information signal except the first information signal, selects a combination of the spread codes corresponding to the first information signal, and performs spread modulation processing to the second information signal using the spread codes of the selected combination, and the receiving side performs despread processing to a received signal by the spread codes used on the transmitting sides selects the combination of the spread codes used on the transmitting side by use of a despread signal, and obtains the first information signal by the combination of the spread codes from the combination of the spread codes, so that information can be placed on the combination of the spread codes to perform data transmission and transmission efficiency can be improved in the data transmission.

This application is based on the Japanese Patent Application No. 2002-000616 filed on Jan. 7, 2002, entire content of which is expressly incorporated by reference herein.

### INDUSTRIAL APPLICABILITY

The present invention is suitable for used in a digital radio communication system, particularly CDMA radio communication.

1. A radio communication apparatus comprising:
selecting means for selecting a combination of spread codes corresponding to a first information signal;
a plurality of spreading means for performing despread modulation processing to a second information signal except the first information signal using the spread codes of the selected combination; and
transmitting means for transmitting the spread codes corresponding to the first information signal and the second information signal spread by said spreading means.

2. The radio communication apparatus according to claim 1, further comprising error correction coding means for performing error correction coding to the first information and the second information signal individually.

3. A radio communication apparatus comprising:
a plurality of despreading means for performing despread processing to a received signal by spread codes used on a transmitting side;
selecting means for selecting a combination of spread codes used on the transmitting side by use of the respective despread signals of said plurality of despreading means;
bitmapping means for obtaining an information signal by a combination of spread codes from the combination of the spread codes; and
multiplexing means for outputting the received signal from the respective despread signals of said plurality of despreading means and the information signal obtained from said bitmapping means.

4. The radio communication apparatus according to clam 3, further comprising error correction decoding means for performing error correction decoding to the respective despread signals of said plurality of despreading means and the signal from said bitmapping means individually.

5. A radio base station apparatus including the radio communication apparatus according to claim 1.

6. A communication terminal apparatus including the radio communication apparatus according to claim 1.

7. A radio base station apparatus including the radio communication apparatus according to claim 3.

8. A communication terminal apparatus including the radio communication apparatus according to claim 3.

9. A radio communication method comprising the steps of:
in a transmitting side apparatus,
selecting a combination of spread codes corresponding to a first information signal;
performing despread modulation processing to a second information signal except the first information signal using the spread codes of the selected combination; and
transmitting the spread codes corresponding to the first information signal and the second information signal spread by said spreading step;
in a receiving side apparatus,
performing despread processing to a received signal by the spread codes used on the transmitting side;
selecting a combination of spread codes used on the transmitting side by use of the despread signals;
obtaining a first signal by a combination of spread codes from the combination of the spread codes; and
outputting the received signal from the second information signal and the first information signal.

10. A radio communication method according to claim 7, wherein in a transmitting side apparatus, error correction coding is performed to a first information signal and a second information signal individually, in a receiving side apparatus, error correction decoding is performed to the first information signal and the second information signal individually.
